(19) United States
(12) Patent Application Publication
(10) Pub. No.: US 2006/0026234 A1
(43) Pub. Date: Feb. 2, 2006

(54) System and method for networked computer graphics

(75) Inventors: Alexander E. Chalfin, Mountain View, CA (US); John Craig Dunwoody, Belmont, CA (US); Alpana Kaulgud, Mountain View, CA (US); Paul Jeffrey Ungar, San Francisco, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Silicon Graphics, Inc.

(21) Appl. No.: 10/899,316

(22) Filed: Jul. 27, 2004

(51) Int. Cl. G06F 15/16

(52) U.S. Cl. 709/205

(57) ABSTRACT

Functional components of a computer graphics network are separated from one another across a network. Each of these four components—a computer graphics application, user input functionality for the application, a graphics renderer, and a display for a rendered image—is allocated to its own network component, separate from the other components. This allows, for example, a user in one location to provide input to a desired computer graphics application that may be executing elsewhere. The computer graphics application may then have rendering performed by a renderer that is located at yet another location, e.g., centrally to the network. The display may be in still another location, e.g., a distant conference room or a classroom.

### BACKGROUND OF THE INVENTION

1. Field of the Invention

The invention described herein relates to computer graphics systems in a networked environment.

2. Related Art

Computer graphics processing can generally be broken down into four functional areas. First, a computer graphics application must be executing. Second, a user's input must be provided to the application, in order to control the graphics process. Third, a renderer must generate data that represents an image, based on instructions received from the computer graphics application. Fourth, the image generated by the renderer must be displayed or otherwise output. In a traditional architecture, all four of these functions are performed at a single computer or work station. The computer graphics application executes on the computer based on inputs provided locally by the user. The rendering process, in turn, acts on instructions received from the computer graphics application, and produces data corresponding to an image. This data is then used in generation of an image that is displayed locally.

While this architecture represents the traditional approach, there are disadvantages. For example, in an environment where there are multiple users, every user requires each of these four components. Every user requires an input mechanism, such as a keyboard, a mouse, a light pen, or other input device(s), and some form of interface for the graphics application. In addition, each user requires a copy of the computer graphics application, as well as dedicated rendering resources. Finally, each user requires his own display or other output device.

Given multiple users, one way to satisfy these requirements would be to provide a graphics workstation for every user. This is expensive and potentially wasteful, especially if not every user is performing significant computer graphics processing. Any given user's computer graphics application may be sitting idle for much of the time. Likewise, the user's rendering logic will also be sitting idle for much of the time. In this arrangement, resources are therefore being used inefficiently. In addition, if an update is required to, say, the computer graphics application, every user must be updated for reasons of compatibility. If one instance of the application is upgraded, every copy of that application must be upgraded. This can be a great expense, especially in an enterprise environment.

Hence, there is a need for a design and a design approach for computer graphics architectures where these limitations are overcome. In particular, a design and design approach are needed wherein the resulting architecture features efficient use of resources, and configuration management is not burdensome.

### SUMMARY OF THE INVENTION

The invention described herein is a system and method for networked computer graphics, wherein the functional components of the system are all separable from one another across a network. Each of these four components—a computer graphics application, user input functionality for the application, a graphics renderer, and a display for a rendered image—is allocated to its own network component, separate from the other components.

The invention allows, for example, a user in one location to provide input to a desired computer graphics application that may be executing elsewhere. The computer graphics application may then have rendering performed by a renderer that is located at another location, e.g., centrally to the network. The display may be in yet another location, e.g., a distant conference room or a classroom. Such a system can be referred to as a Visual Area Network (VAN).

Further embodiments, features, and advantages of the present invention, as well as the structure and operation of the various embodiments of the present invention, are described below with reference to the accompanying drawings.

### BRIEF DESCRIPTION OF THE DRAWINGS/FIGURES

FIG. 1 is a data flow diagram illustrating the four functional components of a computer graphics system.

FIG. 2 is a block diagram illustrating the interaction of the four components with respect to one another.

FIG. 3 illustrates the allocation of each of the four components to its own distinct network component, according to an embodiment of the invention.

FIG. 4 is a block diagram illustrating an alternative allocation of the four functional components, according to an embodiment of the invention.

FIG. 5 is a flowchart illustrating the design process of the invention, according to an embodiment of the invention.

### DETAILED DESCRIPTION OF THE INVENTION

A preferred embodiment of the present invention is now described with reference to the figures, where like reference numbers indicate identical or functionally similar elements. Also in the figures, the left most digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and applications.

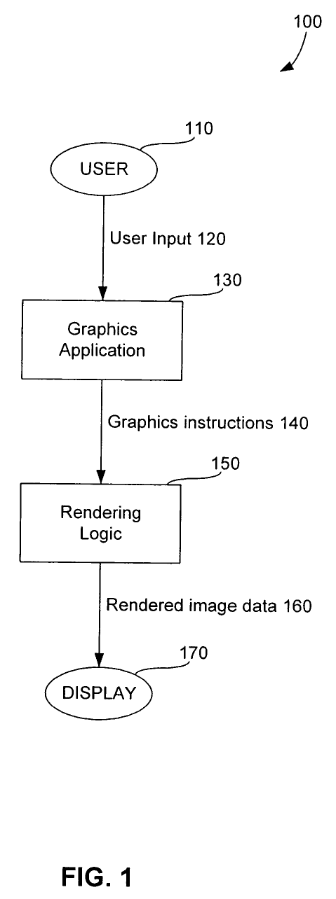

Computer graphics processing is illustrated generally in FIG. 1. A user 110 provides input 120 to a computer graphics application 130. Based on user input 120, graphics application 130 produces instructions 140 which are then provided to rendering logic 150. Rendering logic 150 is sometimes referred to as a renderer. Rendering logic 150 then produces data that corresponds to an image. The output of rendering logic 150 is shown as rendered image data 160. Image data 160 is then used to create an image at display 170 or at some other output device such as a printer or a memory device (e.g., semiconductor memory, magnetic memory, optical memory or the like). In a preferred embodiment, display 170 is a CRT (cathode ray tube) display device, an LCD (liquid crystal display) device, an active matrix display, an image projector, or the like.

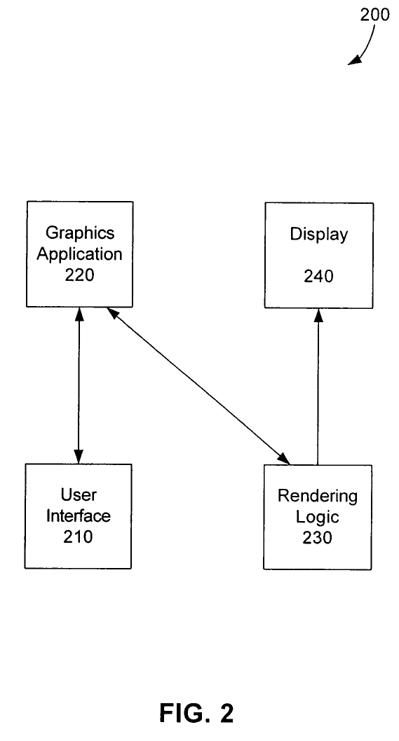

User input functionality, the graphics application, the renderer and the display can be viewed as separable but communicating components of the computer graphics processing system. This is shown in FIG. 2. A user interface 210 accepts user input to a computer graphics application 220. Interface 210 can include a keyboard, touch-sensitive screen, mouse, or other pointing device, and/or a graphical interface to application 220.

Graphics application 220 is also in communication with rendering logic 230. This allows rendering of an image, based on instructions received by rendering logic 230 from the graphics application 220. Rendering logic 230 then creates an image that is forwarded to display 240. Examples of graphics application 220 include drawing software, animation software, CAD (computer aided design) software, CAM (computer aided manufacturing) software, simulator software, and any other computer program that generates pictorial, video or graphical output.

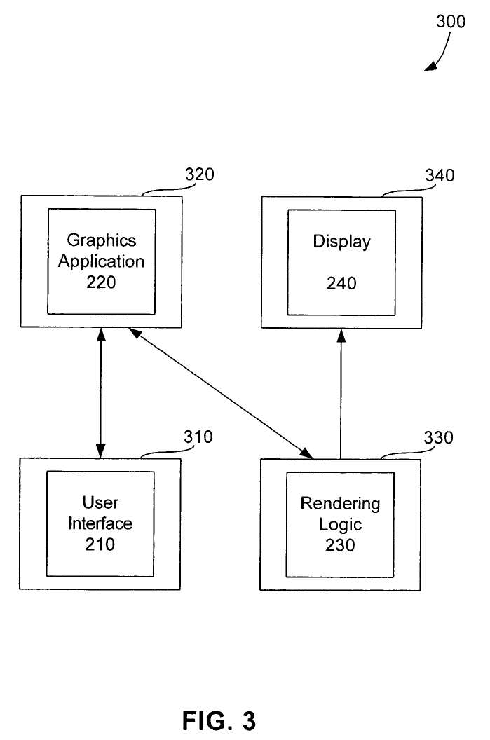

This functional separability can be achieved in a design approach in which each of these four functions is implemented in its own network component. One example of a computer graphics system implemented according to this design approach is illustrated in FIG. 3. Here, the user interface 210, the graphics application 220, the renderer 230, and the display 240 are each implemented in a separate network component. These network components are illustrated as components 310, 320, 330, and 340, respectively. A network component can be a server computer or client computer or any computing platform having the necessary computing capability and network connectivity, such as a Windows, UNIX, or Linux-based computer; a Macintosh computer; a graphics workstation; or a micro, mini, mainframe or super computer.

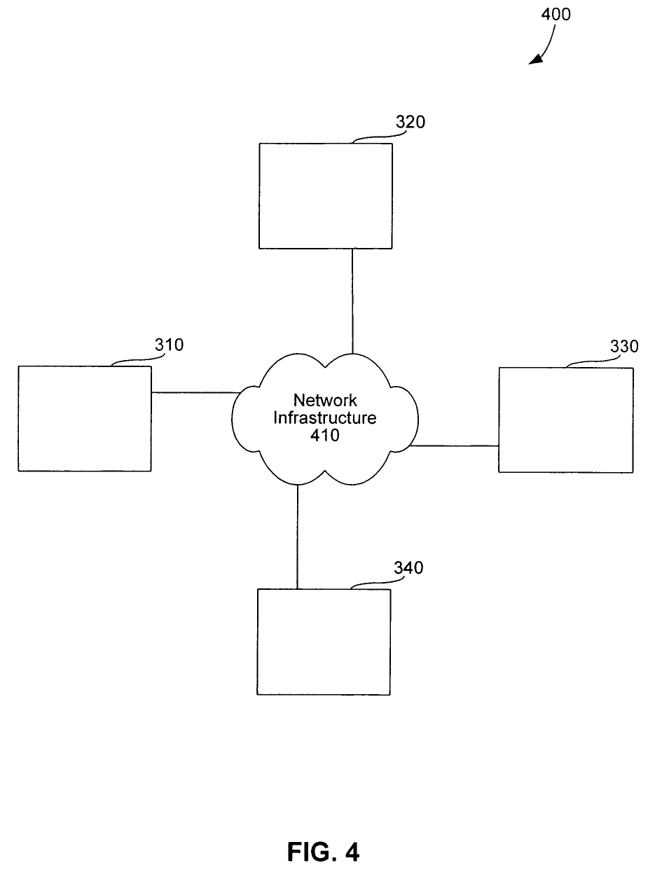

As would be known to persons of skill in the art, connectivity between components can be implemented by a network infrastructure comprising cable or wireless connections, or any combination thereof, that can be switched, routed, or direct. This is shown generally in FIG. 4. Here, each of network components 310, 320, 330, and 340 is shown in communication with the other components via a network 410. The network protocol(s) governing communications between the components can be Transmission Control Protocol/Internet Protocol (TCP/IP), or any other appropriate network protocol suite. In a preferred embodiment, the network may be a LAN (local area network), a WAN (wide area network), a MAN (metropolitan area network), an intranet, an internet, or the global Internet.

In one embodiment, a network component can be a sub-network of computers. A “sub-network” is a network of computers that is in communication with the network that interconnects the four components (e.g., input, application, rendering or display) of the computer graphics system of the invention. The function (e.g., input, application, rendering or display) to be performed by the sub-network can be distributed across two or more computers of the sub-network. The results of such sub- or distributed computing can then be composited by one of the computers in the sub-network.

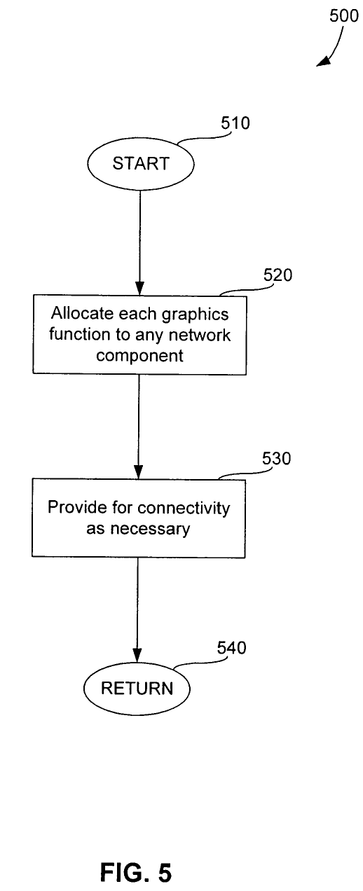

The process of such a design approach is illustrated in FIG. 5. The process begins at step 510. In step 520, each of the four graphics functions is allocated to a network component. In step 530, the necessary connectivity is provided among the various network components. In step 540, the process concludes.

While various embodiments of the present invention have been described above, it should be understood that they have been presented by way of example, and not limitation. It will be apparent to a person skilled in the relevant art that various changes in detail can be made therein without departing from the spirit and scope of the invention. Thus, the present invention should not be limited by way of the above-described exemplary embodiments, but should be defined only in accordance with the following claims and their equivalents.

What is claimed is:

1. A method for operating a computer graphics system having user input functionality, a graphics application, a renderer and an image output device, the method comprising:
allocating, to a first network component, the user input functionality;
allocating, to a second network component, the graphics application;
allocating, to a third network component, the renderer;
allocating, to a fourth network component, the image output device; and
providing communications between the first, second, third and fourth network components, wherein the communications enable user input to be sent from the first network component to the graphics application, graphics instructions to be sent from the second network component to the renderer, and rendered data to be sent from the third network component to the output device.

2. The method of claim 1, wherein the image output device is a display device.

3. The method of claim 1, wherein the output device is a memory device.

4. The method of claim 1, wherein the providing step comprises providing communications over a computer network.

5. The method of claim 4, wherein the providing step comprises providing communications over the global Internet.

6. The method of claim 1, wherein at least one of the first, second, third or fourth network components is a sub-network.

7. The method of claim 6, wherein the sub-network distributes an assigned functionality across at least two computers.

8. A networked computer graphics system, comprising:
a first network component including a graphics application that executes thereon;
a second network component that accepts user input for the graphics application, generates input signals corresponding to the user input, and sends the input signals to the graphics application at the second network component via a network infrastructure;
a third network component at which graphics rendering is performed based on graphics instructions received via the network infrastructure from the graphics application, the rendering generating image data in response to the graphics instructions from the graphics application; and
a fourth network component that receives the image data from the third network component via the network infrastructure, and outputs an image based on the image data.

9. The system of claim 8, wherein the fourth network component comprises a display device for output of the image.

10. The system of claim 8, wherein the fourth network component comprises a memory device for output of the image.

11. The system of claim 8, wherein the network infrastructure comprises a computer network.

12. The system of claim 11, wherein the network infrastructure comprises the global Internet.

13. The system of claim 8, wherein at least one of the first, second, third or fourth network components is a sub-network.

14. The system of claim 13, wherein the sub-network distributes an assigned functionality across at least two computers.

15. A method of computer graphics processing, comprising:
executing a graphics application at a first network component;
accepting, at a second network component, user input for the graphics application;
generating, at the second network component, input signals corresponding to the user input;
sending the input signals from the second network component to the first network component via a network infrastructure;
using the input signals at the graphics application to produce graphics instructions;
sending the graphics instructions from the first network component to a third network component via the network infrastructure;
using the graphics instructions to render an image at the third network component;
sending the rendered image to a fourth network component via the network infrastructure; and
outputting the rendered image at an output device at the fourth network component.

16. The method of claim 15, wherein the outputting step comprises displaying the rendered image on a display device.

17. The method of claim 15, wherein the outputting step comprises storing the rendered image in a memory device.

18. The method of claim 15, wherein the sending steps send signals via a computer network.

19. The method of claim 18, wherein the sending steps send signals via the global Internet.

20. The method of claim 15, wherein at least one of the first, second, third or fourth network components is a sub-network, wherein the sub-network distributes an assigned functionality across at least two computers.
